(19) United States
(12) Patent Application Publication
(10) Pub. No.: US 2012/0242437 A1
(43) Pub. Date: Sep. 27, 2012

(54) ELECTROMAGNET DRIVE FOR A VALVE

(75) Inventors: Werner Buse, Kaarst (DE); Franz-Josef Schnelker, Neuss (DE); Rolf Dohrmann, Kaarst (DE)

(73) Assignee: PIERBURG GMBH, NEUSS (DE)

(21) Appl. No.: 13/514,053

(22) PCT Filed: Nov. 5, 2010
(86) PCT No.: PCT/EP10/66924

§ 371 Date: Jun. 6, 2012

(30) Foreign Application Priority Data
Dec. 8, 2009 (DE) 102009057131.0

(51) Int. Cl. H01F 3/00

(52) U.S. Cl. 335/298

(57) ABSTRACT

An electromagnet drive for a valve includes a piston element. A housing comprises an electromagnetic circuit, a coil wound onto a coil former, an armature mounted to move between a first and second end position to act on the piston element, a core, and a magnetisable return device. The core and/or the magnetisable return device comprises an adjusting bore. The core or the magnetisable return device comprises a substantially circumferential cutout in a region of the adjusting bore on a side facing the coil. A fixing device fixes the armature in a non-energized state. An adjusting device adjusts a magnetic force. The adjusting device comprises an adjusting screw which influences a profile of magnetic field lines. The adjusting screw is insertable into the adjusting bore of the core or the magnetisable return device in a direction of the armature. Energizing the coil moves the armature into the first or second end position.

CROSS REFERENCE TO PRIOR APPLICATIONS

This application is a U.S. National Phase application under 35 U.S.C. §371 of International Application No. PCT/EP2010/066924, filed on Nov. 5, 2010 and which claims benefit to German Patent Application No. 10 2009 057 131.0, filed on Dec. 8, 2009. The International Application was published in German on Jun. 16, 2011 as WO 2011/069759 A1 under PCT Article 21(2).

### FIELD

The present invention provides an electromagnet drive for a valve with a housing with at least one electromagnetic circuit, which is constructed from a coil, which has been wound onto a coil former, an armature, at least one core and at least one magnetizable magnetic return device, wherein the armature is mounted movably between two end positions and acts at least indirectly on a piston element, wherein means are provided which fix the armature in the non-energized state, wherein energization of the coil causes a movement of the armature into the first end position or the second end position, wherein means for adjusting the magnetic force are provided.

### BACKGROUND

Such electromagnet drives are described, for example, in DE 41 10 003 C1 which describes an electromagnet drive for a pneumatic pressure transducer. Due to component tolerances or to a certain choice of materials, a scattering of the magnetic force inevitably occurs, necessitating an adjustment of the magnetic force after the electromagnet drive has been assembled. DE 41 10 003 C1 describes an adjustment wherein an adjustment screw in an iron core of the electromagnet drive, which is also adjustable, can be used for a fine adjustment of the magnetic force. This kind of adjustment has a drawback in that this fine adjustment only has a very limited thread depth and does not act linearly.

### SUMMARY

An aspect of the present invention is to provide an electromagnet drive that avoids the above mentioned drawbacks and can be manufactured in an economic manner from as few components as possible.

In an embodiment, the present invention provides an electromagnet drive for a valve which includes a piston element. A housing comprises at least one electromagnetic circuit, a coil wound onto a coil former, an armature mounted so as to move between a first end position and a second end position so as to act at least indirectly on the piston element, at least one core, and at least one magnetisable magnetic return device. At least one of the at least one core and the at least one magnetisable magnetic return device comprises an adjusting bore. The at least one core or the at least one magnetisable magnetic return device comprises a substantially circumferential cutout in a region of the adjusting bore on a side facing the coil. A fixing device is configured to fix the armature in a non-energized state. An adjusting device is configured to adjust a magnetic force. The adjusting device comprises an adjusting screw configured to influence a profile of magnetic field lines. The adjusting screw is configured so as to be insertable into the adjusting bore of the at least one core or of the at least one magnetisable magnetic return device in a direction of the armature. An energization of the coil moves the armature into the first end position or into the second end position. It is thus possible, in a simple manner, to increase the number of magnetic flux lines in the region of the transition to the armature and to thereby directly influence the magnetic force, the cutout representing a scattering of the magnetic flux lines and causing a decrease in the flux line density in the edge zone.

### BRIEF DESCRIPTION OF THE DRAWINGS

The present invention is described in greater detail below on the basis of embodiments and of the drawings in which:

FIG. 1 shows a schematic sectional view of a electromagnet drive according to the present invention with the adjusting screw in a first position; and

FIG. 2 shows a schematic sectional view of an electromagnet drive according to the present invention with the adjusting screw in a second position.

### DETAILED DESCRIPTION

In order to be able to make as fine an adjustment as possible, the cutout can be a groove whose penetration depth increases substantially linearly at least on the side facing towards the armature.

A structure that is favorable in terms of assembly is obtained by the fact that the core is provided at the end of the electromagnet drive remote from a piston element and comprises the adjusting bore. It is also advantageous if the core comprises an adjustable stop element cooperating with the armature.

The magnetic return device may be provided with a plain bearing bush to support the armature. In an advantageous embodiment, the adjusting screw is arranged in that adjusting bore through a thread or a knurling.

Another manufacturing advantage is obtained if the core has a throughgoing bore into which both the adjusting screw and the stop element can be inserted. In an advantageous manner, the adjustment screw used is a set screw.

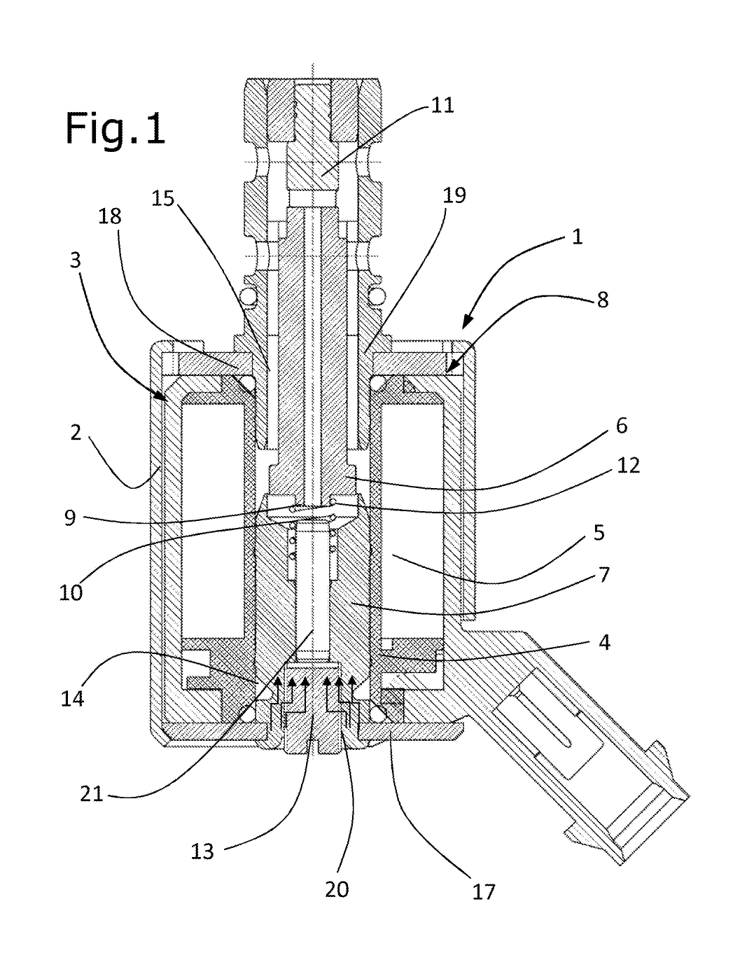

FIG. 1 shows a schematically illustrated electromagnet valve 1 according to the present invention which, in the present embodiment, acts on an armature 6 indirectly or directly connected with a piston element 11, designed in the present case as a pressure regulating valve. In this context, a short explanation of the function of such a pressure regulating valve shall be provided:

Similar to an on-off valve, the oil pressure regulator has ports for the pilot pressure (p2) and the oil pan (p0). Different from an on-off valve, the pressure regulator has an additional port for the delivery pressure (pl) at the bottom end. This pressure (p1) acts on the piston element 11 and functions as a pressure return, known in the context of regulators as regulation return. With respect to direction and sum, the magnetic force and the pressure (p1) act against a spring. When the pressure regulator is designed properly, the sum of the magnetic force and the pressure force (p1) is supposed to move the armature 6 against the spring force. The armature 6 is here intended to more or less clear the transversal bores, to thereby vary the pilot pressure. Overall, this approach allows for obtaining a regulator-like behavior.

It should be appreciated, however, that the illustrated embodiment of the electromagnet drive 1 is suitable for all types of valves.

In the present embodiment, the electromagnet drive 1 comprises a housing 2 with an electromagnetic circuit 3, with a coil 5 being wound on a coil former 4. A core 7 is further provided at the end of the electromagnet drive 1 remote from the valve closing element 11, the core being fastened in a magnetic return device 8 by means of non-illustrated snap-in hooks in the coil former 4.

In the present embodiment, the magnetic return device is formed, in a manner known per se, substantially by three magnetic return sheets of which only two are illustrated, namely 17 and 18.

In the initial state shown, the armature 6 is fixed in a first, upper end position 9. In the present instance, this fixation is achieved through the spring force of a spring 12. However, it is also contemplated to provide a diaphragm with a spring at a suitable position, which would have the additional advantage that the electromagnet drive would be protected against soiling.

The axially movable armature 6 is supported in a housing part 19 by means of a plan bearing bush 15, which in the present embodiment is a DU bush.

When the electromagnet drive 1 is energized, the magnetic flux lines will assume the profile illustrated in FIG. 1, with the magnetic forces generated causing an oppositely directed adjusting force of the armature 6, and move the same towards the core 7. A non-magnetizable stop element 21 is further provided on which the armature 6 abuts in the second end position 10.

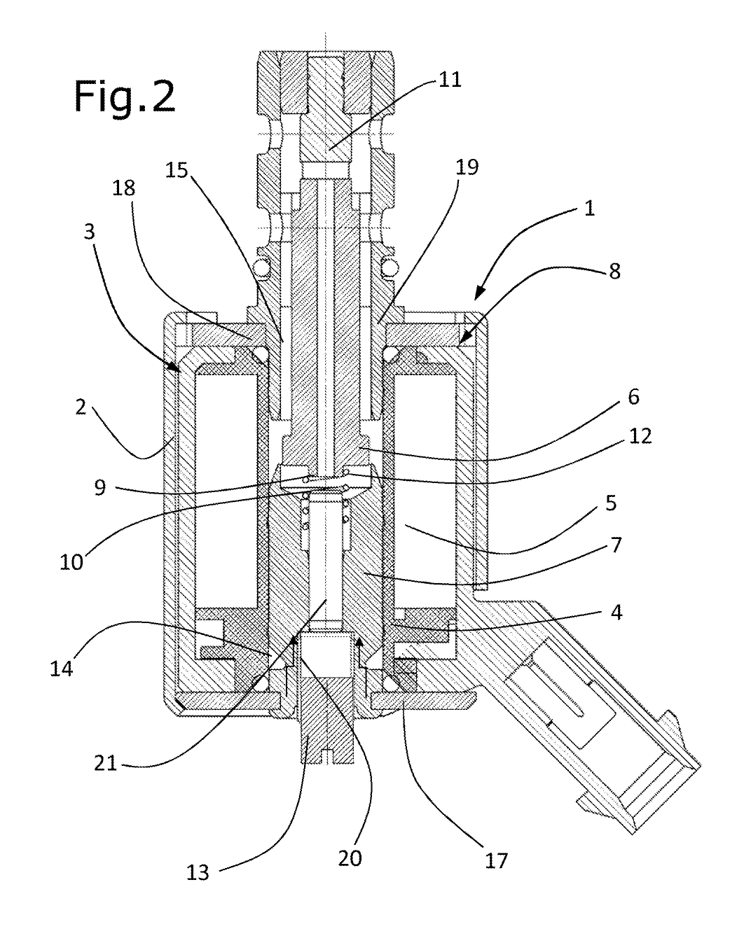

If it turns out, after assembly, that the magnetic force resulting from a predetermined current is not within the desired tolerance range, a fine adjustment of the electromagnet drive 1 can be made by means of an adjusting screw 13 in an adjusting bore 20. To this end, the adjusting screw 13, arranged in the core 7 via a thread or a knurling, can be moved in the axial direction of the electromagnet drive 1. In the embodiment shown in FIG. 1, the maximum magnetic force is set by the position of the adjusting screw. Turning the adjusting screw 13 out will result in a decrease in the number of magnetic flux lines in the core, as shown in FIG. 2, and thereby the magnetic force will be reduced significantly. In order to provide as linear an adjustment as possible over the adjustment length of the adjusting screw 13 and to prevent a scattering of the magnetic flux lines in the core 7, a circumferential cutout 14 is provided in the region of the adjusting bore 20 on the side of the core 7 directed towards the coil 5.

It is advantageous, especially with a fast oscillating movement of the armature 6, to provide the armature 6 with a pressure relief bore.

After adjustment by means of the adjusting screw 13, the electromagnet drive 1 can be covered with a cover, not shown in detail herein, provided in the region of the core 7.

In order to prevent an undesired readjustment of the adjusted position of the adjusting screw 13 in the core 7, weld points can be provided, for example, in the region of the transition between the adjusting screw 13 and the core 7. It is also possible to provide a fixation by means of pins.

The adjusting screw 13 does not necessarily have to be provided with a thread or a knurling. It may be designed as a set screw adapted to be inserted into a throughbore in the magnet return device 8. It is also possible to provide a core 7 that is adapted to be adjusted in the electromagnet drive, thereby providing for a rough adjustment of the magnetic force.

The present invention is not limited to embodiments described herein; reference should be had to the appended claims.

What is claimed is:

1-8. (canceled)

9. An electromagnet drive for a valve, the electromagnet drive comprising:
a piston element;
a housing comprising at least one electromagnetic circuit, the at least one electromagnetic circuit comprising:
a coil wound onto a coil former,
an armature mounted so as to move between a first end position and a second end position so as to act at least indirectly on the piston element,
at least one core, and
at least one magnetisable magnetic return device,
wherein at least one of the at least one core and the at least one magnetisable magnetic return device comprises an adjusting bore, and
wherein the at least one core or the at least one magnetisable magnetic return device comprises a substantially circumferential cutout in a region of the adjusting bore on a side facing the coil;
a fixing device configured to fix the armature in a non-energized state; and
an adjusting device configured to adjust a magnetic force, the adjusting device comprising an adjusting screw configured to influence a profile of magnetic field lines, the adjusting screw being configured so as to be insertable into the adjusting bore of the at least one core or of the at least one magnetisable magnetic return device in a direction of the armature,
wherein an energization of the coil moves the armature into the first end position or into the second end position.

10. The electromagnet drive as recited in claim 9, wherein the substantially circumferential cutout is a groove with a penetration depth which increases substantially linearly at least on a side facing the armature.

11. The electromagnet drive as recited in claim 9, wherein the core is arranged at an end of the electromagnet drive remote from the piston element, and the core comprises the adjusting bore.

12. The electromagnet drive as recited in claim 11, wherein the core comprises a throughgoing bore configured so that both the adjusting screw and the stop element can be inserted therein.

13. The electromagnet drive as recited in claim 9, wherein the core comprises an adjustable stop element configured to cooperate with the armature.

14. The electromagnet drive as recited in claim 9, wherein the at least one magnetisable magnetic return device comprises a plain bearing bush configured to support the armature.

15. The electromagnet drive as recited in claim 9, wherein the adjusting screw is arranged in the adjusting bore via a thread or a knurling.

16. The electromagnet drive as recited in claim 9, wherein the adjusting screw is a set screw.
